(19) United States
(12) Patent Application Publication
(10) Pub. No.: US 2008/0061145 A1
(43) Pub. Date: Mar. 13, 2008

(54) Identifier Scanning Joinder Tools

(76) Inventor: Kevin David McGushion, Simi Valley, CA (US)

Correspondence Address: AARON PAUL MCGUSHION, 16470 HARBOUR LANE, HUNTINGTON BEACH, CA, 92649, US

(21) Appl. No.: 11/688,850

(22) Filed: Mar. 20, 2007

Related U.S. Application Data
(60) Provisional application No. 60/783,792, filed on Mar. 20, 2006.

(51) Int. Cl. G06F 19/00; G06Q 90/00

(52) U.S. Cl. 235/462.13; 235/385; 29/407.04

(57) ABSTRACT

A joinder system comprising: a joinder tool, the joinder tool being used to join a plurality of parts, an assembly being comprised of the plurality of parts, at least one of the plurality of parts being associated with a part identity; a part identity reading means, the part identity reading means being coupled to the joinder tool; a part identity database, the part identity database containing information associated with at least one of the plurality of parts, the part identity database resident on a computing means, each the part identity being associated with a dataset within the part identity database, each the dataset containing information associated with each the part; a data transmission means, the data transmission means facilitating data communication between at least the part identity database resident on the computing means and the part identity reading means; wherein the part identity reading means automatically or intentionally reading the part identity during an assembly process; and wherein the part identity being decoded, compared, and matched to a correlating dataset, the reading of the part identity being recorded as an occurrence on the computing means.

### CROSS-REFERENCE TO RELATED APPLICATIONS

This application is entitled to the benefit of Provisional Application for Patent Ser. No. 60/783,792 filed on Mar. 20, 2006.

### BACKGROUND OF THE INVENTION

The present invention relates generally to joinder manufacturing processes, and more particularly, to the tools used in the joinder processes and the identification of parts joined within an assembly.

It is of critical importance, in modern manufacturing processes, to ensure traceability of products, and the materials and parts comprising the products. Traceability is often achieved through the use of identifiers, either generic or unique. Individual items can be traced throughout the manufacturing process, tracking quality and inventory data, as well as being used to track and respond to demand. These identifiers can also be used to identify and track parts in components assembled at a site separate from the manufacturing site, as often happens in the construction, aerospace, semiconductor, process industries, and others. Identifiers can be used by manufacturers, distributors, end users, or any other entity in the usage chain. Identifiers can be used to reference documentation, tracking serial numbers, material IDs, date codes, test data, performance information, inspection data, inventory, finance information, and numerous additional data.

A great many manufacturing processes use identifiers to track quality, inventory, assembly, service, and recycling of products, and the components comprising the product. Identifiers can be in the form of optical identifiers such as bar-codes, inductive transmitting/receiving devices, or other form of ID memory, alpha-numeric codes, and other identification technologies. The identification can be inscribed on the part or product, stamped, embedded, or a tag identification means can be attached. The identification means being appropriate for the product type and expected usage environment.

Currently, if the identification of all the parts (including components, fasteners, and the like) within an assembly is desired, a scanning device is needed, such as a laser scanner for a barcode type identifier. The items can be scanned as they are withdrawn from inventory or as they are assembled. Primarily, only the significant components are scanned and many of the ancillary parts, such as fasteners, washers, seals, and other joinder parts, are not scanned individually.

A known possible assembly process would start with a parts list on the design drawing. Each part shown in the drawing is listed in the parts list, including such information as the name, part number, quantity needed, and similar information. The assembler gathers the parts needed for the assembly from inventory, the quantity of each part being dictated by the parts list. The assembler may scan the parts bin with the barcode scanner to verify that the part is correct and for inventory control purposes.

The gathered parts are then taken to the assembly area, where the various parts, components, fasteners, and others, are assembled into a subassembly or assembly. A prescribed assembly process is followed by the assembler. When the assembly is complete, the assembler can visually check the bin or tray used to gather the parts form inventory, checking for remaining parts forgotten in the assembly process.

If a part is forgotten, for instance if a washer is remaining, the assembler must determine where the part belongs within the assembly. If the assembler is fortunate, the location of the missing washer within the assembly will be easily found and easily accessible, and can be quickly inserted without an unacceptable setback in the schedule. Often, in more complex assemblies though, the installed location of the forgotten part is nestled well within the assembly, obscured from view and inaccessible from the outside.

The assembler has a couple of choices at this stage, disassembling the assembly to gain access to the location or to simply ignore the forgotten part. The first option of disassembling the assembly is the only sound option at this point, however this still being a tremendous waste of time. If the assembly is complex, the time to insert the forgotten part can set the production schedule back and reduce profit. If this is a repeated problem in various assemblies, the overall profitability of the production line can be severely curtailed, if not eliminated.

The second option of ignoring the forgotten part is extremely undesirable on the part of the company, for obvious reasons, such as product safety, reliability, and correct operation. Under pressure from management to produce perfect assemblies the first time, the assembler may choose to hide the forgotten part rather than face disciplinary actions. Especially if the forgotten part will not be noticed upon further inspection by others, the assembler may view the option of ignoring the part as being best.

Another issue in the assembly process is monitoring the exact assembly procedure, including torque, temperature, pressure, and other settings required for correct assembly. For example, when tightening fasteners, a torque setting may be specified on the design, relying ultimately on the assembler to adhere to this recommendation. For various reasons, the actual torque setting can deviate from the specified setting. The assembler may neglect to check the setting on the assembly tool regularly, the torque setting being inadvertently altered through regular use. Alternatively, an inexperienced or careless assembler may not check the setting at any point. An incorrect torque setting can cause problems down the road, during operation, possibly vibrating loose if under-torqued, or deforming a part if over-torqued. Depending on the mechanism and the severity of the torque error, many adverse conditions can result during use.

A further issue in the assembly process could be the use of a tool that is not appropriate for a particular joint in the assembly. An example would be the incorrect socket size for a particular bolt head. It is possible that a larger size or different system of measurement (metric or US customary) appears to fit the bolt. However, upon tightening, the large socket damages the bolt, possibly stripping it. The damaged bolt must be removed and replaced before proceeding. A stripped bolt may need to be removed using more intensive techniques.

During the assembly process it is also common to assemble the parts in the wrong order. An example of this occurs when two components are being fastened together, using a bolt, nut, two lock washers, and two washers. The design may specify that one lock washer is inserted over the bolt, followed by the washer. This bolt assembly is inserted through the first component, and then through the second component, the threaded end of the bolt extending from the second component. Then, a washer followed by a lock washer is inserted over the bolt. Finally, the nut is threaded on the bolt. The assembly order is designated stepwise to prevent loosening of the nut during use and to increase the contact area between the fastener and the components. If, however the lock washer and washer are reversed, their purpose may be defeated.

Yet another problem experienced during assembly could be the installation of an incorrect part. This type of mistake could involve using the wrong screw length, installing the incorrect valve, or many other similar mistakes wherein the installer believes, based on appearance, that the correct part has been installed.

What is needed in the art and heretofore has not been available is a means for automatically or intentionally scanning the identification of all parts of an assembly as they are being assembled. What is also needed is a means for comparing the scanned identification data to the parts list, to insure the proper parts and quantities have been installed, preventing missing parts within an assembly. What is additionally needed is a means to insure that every part of an assembly has been installed in the correct order and orientation. What is yet again needed is a means to insure the correct joinder parameters have been observed and the correct tool has been used for the joinder process. Again, what is needed, is a system that communicates the progress of the assembly to all involved parties. The present invention satisfies these and other needs.

### SUMMARY OF THE INVENTION

In accordance with a preferred embodiment of the present invention a joinder system comprising: a joinder tool, the joinder tool being used to join a plurality of parts, an assembly being comprised of the plurality of parts, at least one of the plurality of parts being associated with a part identity, the part identity being machine-readable; a part identity reading means, the part identity reading means being coupled to the joinder tool, the part identity reading means reading a part identity; a part identity database, the part identity database containing information associated with at least one of the plurality of parts, the part identity database resident on a computing means, each the part identity being associated with a dataset within the part identity database, each the dataset containing information associated with each the part; a data transmission means, the data transmission means facilitating data communication between at least the part identity database resident on the computing means and the part identity reading means; wherein the part identity reading means automatically or intentionally reading the part identity during an assembly process; and wherein the part identity being decoded, compared, and matched to a correlating dataset, the reading of the part identity being recorded as an occurrence on the computing means.

### BRIEF DESCRIPTION OF THE DRAWINGS

FIG. 1 is a diagram illustrating one potential use of the present invention.

FIG. 2 is a flowchart showing a method for using the present invention.

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

In accordance with a preferred embodiment of the present invention a joinder system (20) comprising: a joinder tool (22), the joinder tool (22) being used to join a plurality of parts (24, 26, 28, 30), an assembly (32) being comprised of the plurality of parts (24, 26, 28, 30), at least one of the plurality of parts (24, 26, 28, 30) being associated with a part identity (34, 36, 38, 40), the part identity (34, 36, 38, 40) being machine-readable; a part identity reading means (42), the part identity reading means (42) being coupled to the joinder tool (22), the part identity reading means (42) reading a part identity (34, 36, 38, 40); a part identity database (44), the part identity database (44) containing information associated with at least one of the plurality of parts (24, 26, 28, 30), the part identity database (44) resident on a computing means (54), each the part identity (34, 36, 38, 40) being associated with a dataset (46, 48, 50, 52) within the part identity database (44), each dataset (46, 48, 50, 52) containing information associated with each part (24, 26, 28, 30); a data transmission means (56), the data transmission means (56) facilitating data communication between at least the part identity database (34) resident on the computing means (54) and the part identity reading means (42); wherein the part identity reading means (42) automatically or intentionally reading the part identity (34, 36, 38, 40) during an assembly process; and wherein the part identity (34, 36, 38, 40) being decoded, compared, and matched to a correlating dataset (46, 48, 50, 52), the reading of the part identity (34, 36, 38, 40) being recorded as an occurrence on the computing means (54).

The joinder tool (22) can be any tool used to join parts (24, 26, 28, 30) to create an assembly (32), such as a screwdriver, wrench, hex wrench, heat gun, adhesive applier, or any other tool used in the joining of two or more parts (24, 26, 28, 30), manual or machine powered. Either integrated into the joinder tool (22) or coupled thereto, is the part identification reading means (42). Part identities (34, 36, 38, 40) found on the parts (24, 26, 28, 30) can be in the form of optical identifiers such as bar-codes, inductive transmitting/receiving devices, or other form of ID memory, alpha-numeric codes, and other identification reading technologies. Additionally information correlating to the part identity (24, 26, 28, 30) is communicated to an authorized party.

The part identity database (44) can be subdivided into datasets (46, 48, 50, 52), where the parts (24, 26, 28, 30) required for each assembly (32) within a project can be detailed. The datasets (46, 48, 50, 52) can correspond to a parts lists associated with a design drawing. Additionally, the datasets (46, 48, 50, 52) can be integrated with assembly recommendations, including the type of joinder process to be used and the order of assembly.

Each part to be used within an assembly is assigned a part identity (34, 36, 38, 40) by the manufacturer or the assembler. The part identity (34, 36, 38, 40) can either be unique, having information that specifically identifies the part, or generic, having information that does not distinguish it from other parts having the same specification. The parts (24, 26, 28, 30) identified include primary parts, contributing directly to the function of the manufactured device, supporting parts, such as fasteners, seals, and the like, and any other components that may be used within an assembly, and are deemed to be significant.

Additionally, joinder points (threaded holes, through holes, clip points, adhesion points, and the like) of parts (24, 26, 28, 30) can be individually identified within a part (24, 26, 28, 30). For instance, for a part (24, 26, 28, 30) with two threaded holes, each hole is given a specific identity. Scanning the identifier near the first threaded hole can describe the identity of the part (24, 26, 28, 30), the identity and location of the first threaded hole (distinguishing it from the second threaded hole), the type of mating fastener required, and a possible assembly (32) for which the part (24, 26, 28, 30) belongs. Likewise when the identifier of the second threaded hole is scanned, the second threaded hole is individually distinguished. A joinder point identity can be formed by the combination of two joined identities.

When it is not practical to use the joinder tool (22) to scan a part (24, 26, 28, 30), due to limited accessibility or convenience, a stand alone or detachable part identity reading means (42) can also be used to scan the part identity (24, 26, 28, 30) of a part (24, 26, 28, 30) or joinder point.

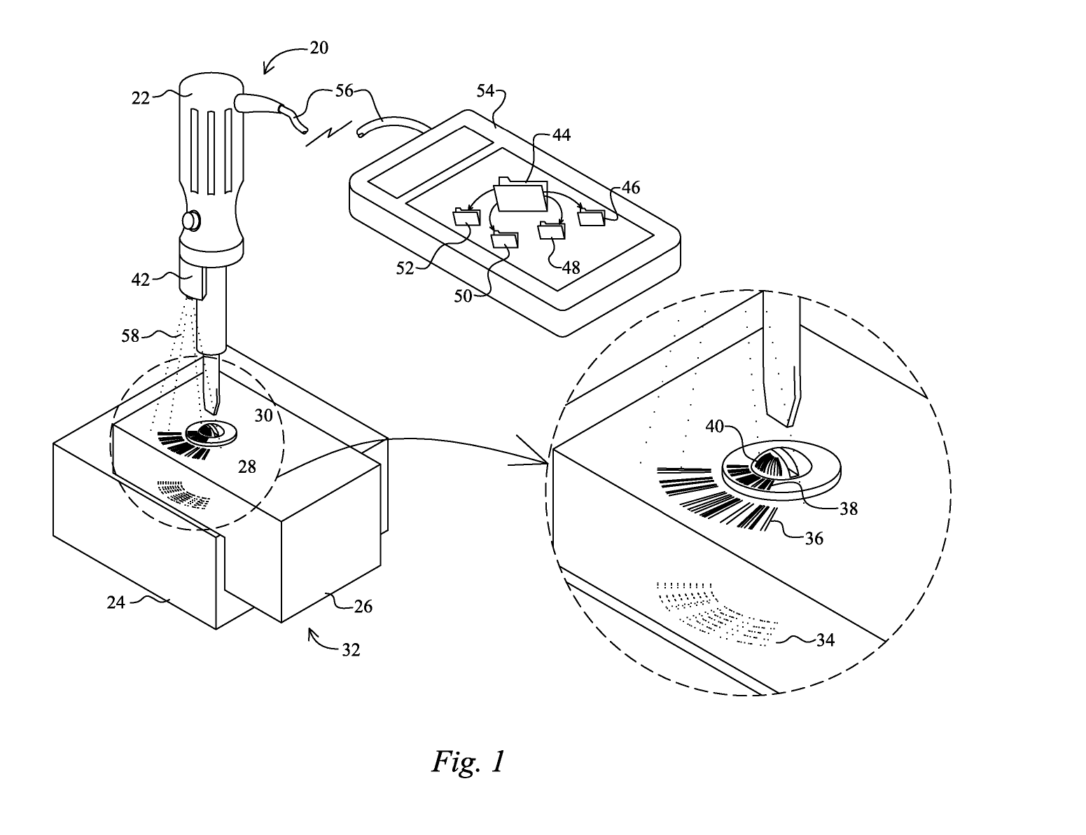

One example of a joinder tool (20) exemplified by the primary embodiment is an electric driver, such as a hex nut driver, screwdriver, or other threaded fastener driver, as seen in FIG. 1. A part identity reading means (42) is integrated within the driver. The part identity reading means (42) is similar to the scanning devices commonly used throughout industry and retail to identify products and parts, having the ability to read the part identities (34, 36, 38, 40) using an interrogation signal (58), the ability to decode the interrogation signal (58), and transmit the identity data to a computing means (54) via a data transmission means (56). The data transmission means (56) could be a data cable or fiber, or wireless transmission means. The part identity reading means (42) is in data communication with a computing means (54), being either an integrated computing means or external computing means. The computing means (54) can be any number of devices, including a notebook computer, handheld computer, server means, or a desktop computer.

When a part identity (34, 36, 38, 40) is read and transmitted to the computing means (54), the part identity (34, 36, 38, 40) is compared to the part identity database (44) to determine the exact part (24, 26, 28, 30) being scanned, and to determine the exact parts needed within a particular assembly (32) and the order of assembly. Information regarding the accuracy of parts selection and recommended assembly order, instructions, and assembly parameters can be communicated to the assembler; or in a more simple embodiment, the joinder tool (20) may just have a signal system, such as a red and green light, to indicate correct and incorrect assembly.

One possible order of assembly could be as case where part (24) is procured first; part identity (34), associated with part (24), is scanned. Then part (26) is connected to part (24); part identity (36), associated with part (26), is scanned. Thereafter, part (28), a washer, is applied to part (26); part identity (38), associated with part (28), is scanned. And finally, part (30), a screw, is inserted through part (28) and part (26), threading into part (24); part identity (40), associated with part (30), is scanned. The actual order of assembly is stored and compared to the order of assembly recommended initially. Further, part identity (34) is associated with dataset (46); part identity (36) is associated with dataset (48); part identity (38) is associated with dataset (50); and part identity (40) is associated with dataset (52)

If possible, the part identities (34, 36, 38, 40) are configured to be read in the assembled configuration. If the part has multiple joinder points, each may have an individual part identity (34, 36, 38, 40) positioned nearby. In the embodiment shown, the part identities (34, 36, 38, 40) encircle the holes of part (24) and part (26), and the upper faces of part (28) and part (30). The part identity (34, 36, 38, 40) can completely encircle the hole or just partially, forming a sectored scanned area.

In one instance, when the screw, part (30), and washer, part (28), are inserted in the through hole of the part (26), the part identity (40) is located on the head of the screw; and the part identity (38) is located on the surface of the washer, having a larger diameter than the screw head, at least partially visible when installed beneath the screw head. Near the clearance hole of the part (26), is the part identity (36), being at least partially visible when assembled with the screw and washer. The part identity (36) for the part (26) identifying not only the part, but also the particular clearance hole nearby. In this configuration, the driver can read the part identity (40) of the screw, the part identity (38) of the washer, and the part identity (36) of part (26) simultaneously while tightening the assembly. The part identity (34) of part (24), possibly being at least partially obscured, should be scanned before the other parts are assembled with it.

Not only can the driver read the identities simultaneously, it can also be determined, to a great degree, in which order the parts are assembled, in an additional embodiment. The ability to read the identities of the screw, washer, and part (26) would indicated that they are assembled in the correct order, one part identifier not being obscured unexpectedly by another part. The part identification reading means (42) is generally situated to read the part identities (34, 36, 38, 40) as the diver is being used to engage and tighten the screw, being pointed generally towards the identifier on each part; although, other orientations of the reading means is possible. As each part and joinder point is scanned, that part's identity is transmitted to the computing means and stored in the computing means (54) memory.

In an alternate embodiment of the present invention assembly parameters, such as torque, orientation, and such, can be specified within a design. Using modern CAD technologies, the assembly parameters can be specified within the design drawing set. These parameters, for each joinder process, can be integrated with the part identity database.

Revisiting the first assembly example, as the threaded hole is scanned on the part (24), the exact identity of the part and the joinder point can be found and correlated to the assembly parameters designated in the design for that joint. Information such as the joinder type, order of assembly, torque settings, adhesive, curing and other information important to the process can be communicated to the assembler through the computing means (54) or an interface on the joinder tool (22). Additionally, joinder tool (22) settings can be communicated to the joinder tool (22) and automatically set without relying on the assembler to adjust the settings. With this, settings, such as torque, can automatically adjusted for each joint scanned, guaranteeing the proper torque setting for each fastener.

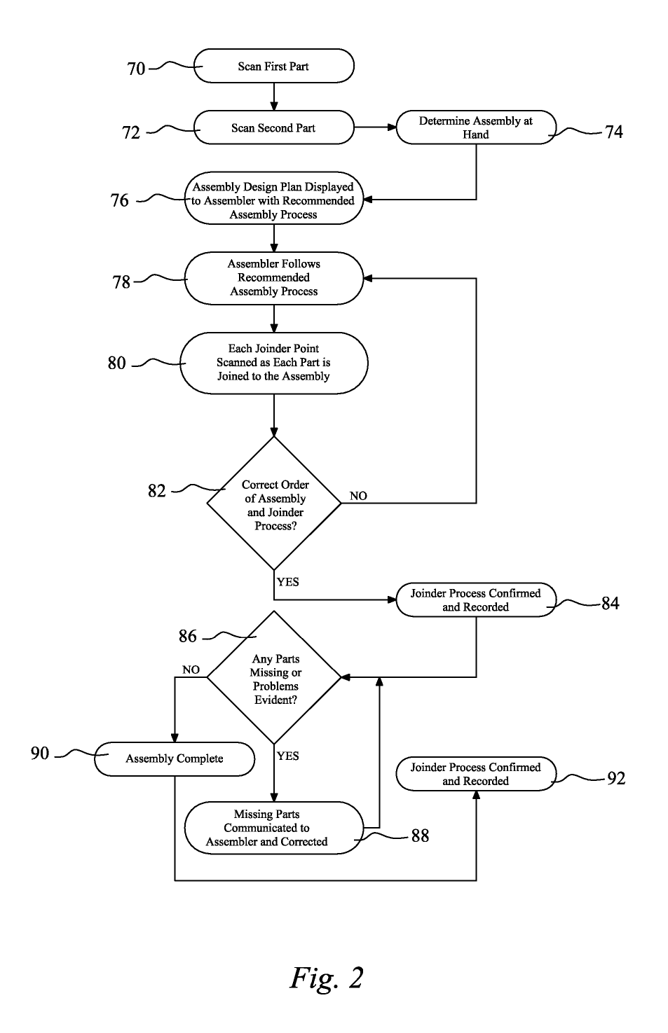

Looking at FIG. 2, one possible method is shown, using the present invention to join parts into an assembly. A first part is scanned (step 70), a second part is scanned (step 72), and the information regarding that part and its corresponding assembly or choice of assemblies is retrieved (step 74); and the assembly plan is displayed to the assembler (step 76). The assembler, following the recommended plan (step 78), scans each part in the order of assembly (step 80). Being connected to a computing means, it is determined immediately if the scanned part is correct and in the correct order of assembly (step 82). As each joinder process is completed, the joinder data it recorded (step 84). Then, if any parts are missing (step 86), those parts are displayed to the assembler (step 88). When complete (step 90), and no parts are missing, the assembly is recorded as completed (step 92).

In yet another alternate embodiment of the present invention, information regarding the status of the various assemblies comprising a complete project is conveyed to all those involved with the project. Many projects are designed using solid models, within a CAD drawing, each part, often down to even screws and nuts, are specified and shown in a three dimensional drawing. An entire project, for example a passenger jet, can involve the assembly of many thousands of parts into hundreds of subassemblies. These subassemblies can be fabricated by many assemblers, from different companies, and different parts of the world. Keeping track of the progress of all of these separate subassemblies is extremely important to the overall manufacturing timeline. Being connected to a central server or series of servers enables the instantaneous tracking required.

Each assembler responsible for a particular subassembly, being connected to the central server, is given access to the CAD design for that subassembly. The assembler adheres to the specified joinder parameters set within the design, and scans each part within the subassembly as the parts are being joined. Information regarding the assembly procedures and progress are sent back to the server automatically, recording which subassembly is being joined, in which order it was assembled, the joinder process used, and any other information that is significant.

The assembler can view the CAD solid model, or two dimensional plan, during assembly. A corresponding virtual subassembly can be displayed, showing the progress of the subassembly to the assembler. For example, the parts, as they are attached to the subassembly, can correspondingly, be attached to the virtual subassembly. As the first part is scanned, the virtual part appears on the computing means display, and the subassembly plan is loaded from the server.

An example virtual subassembly can also be displayed showing, in an animated fashion, the next part to be added and the joinder method needed. As each part is added in the correct order and with the correct method, the virtual subassembly and the example virtual subassembly confirm the correctness of the joint, and the next joinder process is shown. If an error has been made by the assembler, a warning can be issued in the virtual subassembly, with a corrective recommendation.

Other information included on the display could be a virtual parts bin, a parts list, a virtual tool box showing all the tools required for the assembly and indicating the tool being used and if that tool is correct, as well as any other information that is required for a correct assembly. Additionally, if one part within an assembly is forgotten, a warning is issued to the assembler with the identification and installation location of the missing part being indicated.

As each subassembly is completed, the information gathered in the joinder process is sent to the central server; and the over progress of the project can be tracked with virtual models of the project and all of the corresponding data. As an example, when a subassembly is complete, the virtual subassembly is installed into the virtual project solid model, showing that the particular subassembly is ready for actual installation when needed. Subassemblies form many different locations can be tracked centrally, with the virtual model of the project being built as each subassembly progresses. Additionally, information regarding the fabrication of the subassembly is permanently associated with the subassembly and communicated in the virtual model of the project.

Using this information, the project management can track the exact progress of all of the subcontractors in real-time, throughout the fabrication process. They can determine if the project is on schedule and budget, and communicate directly with a subcontractor or assembler if a subassembly is behind schedule.

Having thus described the invention, it is now claimed:

1) A joinder system comprising:
a joinder tool, said joinder tool being used to join a plurality of parts, an assembly being comprised of said plurality of parts, at least one of said plurality of parts being associated with a part identity, said part identity being machine-readable;
a part identity reading means, said part identity reading means being coupled to said joinder tool, said part identity reading means reading a part identity;
a part identity database, said part identity database containing information associated with at least one of said plurality of parts, said part identity database resident on a computing means, each said part identity being associated with a dataset within said part identity database, each said dataset containing information associated with each said part;
a data transmission means, said data transmission means facilitating data communication between at least said part identity database resident on said computing means and said part identity reading means;
wherein said part identity reading means automatically or intentionally reading said part identity during an assembly process;
and wherein said part identity being decoded, compared, and matched to a correlating dataset, the reading of said part identity being recorded as an occurrence on said computing means.

2) The joinder system of claim 1 wherein information correlating to said part identity is communicated to an authorized party.

3) The joinder system of claim 1 wherein said part has at least one joinder point, said joinder point being at a juncture, said joinder point having a joinder point identity, said joinder point identity being associated with information regarding said joinder point within a joinder point dataset within said correlating dataset, said joinder point identity being read by said part identity reading means.

4) The joinder system of claim 1 wherein said part identity reading means is mechanically coupled to said joinder tool and is coupled to said joinder tool via said data transmission means.

5) The joinder system of claim 1 wherein said part identity reading means is coupled to said joinder tool via said data transmission means.

6) The joinder system of claim 1 wherein said computing means is a local computer.

7) The joinder system of claim 1 wherein said computing means is a remote computing means or a server.

8) The joinder system of claim 1 wherein a first part identity is associated with a first part and a second part identity is associated with a second part; an order of assembly for said first part and said second part being determined and communicated to an authorized party; said order of assembly being retrieved from an assembly dataset; said assembly dataset being associated with said part identity database; said assembly dataset containing information regarding said first part identity, said second part identity, said order of assembly, and a method of assembly.

9) The joinder system of claim 8 wherein a parts list and said order of assembly is communicated to an assembler; said first part being indicated as being first in said assembly and said second part being indicated as being second in said assembly;
said assembler using said joinder tool to assemble said assembly; said part identity reading means reading said first part identity; said part identity reading means thereafter reading said second part identity as said first part is assembled with said second part; an actual order of assembly being recorded on said computing means.

10) The joinder system of claim 9 wherein if said order of assembly matches said actual order of assembly a confirmation is communicated to said assembler; if said order of assembly does not match said actual order of assembly an alert is communicated to said assembler, said alert and said confirmation being recorded on said computing means.

11) The joinder system of claim 9 wherein a set of assembly parameters are communicated to said assembler by scanning an assembly design; said set of assembly parameters including an assembly methodology; said assembly design being presented on a medium visually supportive of said assembly design.

12) The joinder system of claim 1 wherein a set of joinder parameters are communicated to said joinder tool; said set of joinder parameters being automatically set on joinder tool subsequent to and resulting from scanning at least one said part identity; said set of joinder parameters affecting at least one joint formed between said plurality of parts.

13) The joinder system of claim 1 wherein each said part identity is correlated to a virtual representation; a first part identity is associated with a first virtual representation and a second part identity is associated with a second virtual representation; the scanning of said first part identity causing said first virtual representation to be displayed on a visually supportive medium; the scanning of said second part identity causing said second virtual representation to be displayed on said visually supportive medium; subsequent to joining said first part and sad second part, said first virtual representation and said second virtual representation are likewise joined in a virtual assembly; said virtual assembly be accessible to an authorized party.

14) The joinder system of claim 1 wherein at least one subsequent virtual part is displayed; said subsequent virtual part demonstrating to an authorized party a subsequent part to be added next to said assembly.

15) The joinder system of claim 1 wherein at least one subsequent virtual joinder tool is displayed; said subsequent virtual joinder tool demonstrating to an authorized party a subsequent joinder tool to be utilized for a subsequent joinder process.
